(19) United States
(12) Patent Application Publication
(10) Pub. No.: US 2023/0002258 A1
(43) Pub. Date: Jan. 5, 2023

(54) SYSTEMS AND METHODS FOR OXIDIZING DISINFECTANTS COMBINED WITH MOVING BED BIOFILM REACTORS

(71) Applicant: Headworks Bio, Inc., Houston, TX (US)

(72) Inventors: Somnath Basu, Houston, TX (US); Robert Reimers, Houston, TX (US); Silva Anappan, Houston, TX (US); Gerald Seidl, Houston, TX (US)

(21) Appl. No.: 17/088,567

(22) PCT Filed: May 3, 2019
(86) PCT No.: PCT/US2019/030673

§ 371 Date: Nov. 3, 2020

Related U.S. Application Data
(60) Provisional application No. 62/666,214, filed on May 3, 2018.

(51) Int. Cl. C02F 1/50; C02F 1/76; C02F 1/32

(52) U.S. Cl. CPC C02F 1/50; C02F 1/766; C02F 1/32; C02F 2303/04; C02F 2307/14

(57) ABSTRACT

In one embodiment, a system includes a disinfection system configured to disinfect a first fluid. The system further includes a moving bed biofilm reactor (MBBR) system configured to treat a second fluid, wherein the disinfection system is fluidly coupled to the MBBR system upstream of the MBBR system, downstream of the MBBR, or wherein the disinfection system is disposed in the MBBR system.

### CROSS-REFERENCE TO RELATED APPLICATION

This application claims priority to and the benefit of Patent Cooperation Treaty (PCT) Application No. PCT/US19/30673, entitled “SYSTEMS AND METHODS FOR OXIDIZING DISINFECTANTS COMBINED WITH MOVING BED BIOFILM REACTORS,” filed on May 3, 2019, and U.S. Provisional Application No. 62/666,214, entitled “SYSTEMS AND METHODS FOR OXIDIZING DISINFECTANTS COMBINED WITH MOVING BED BIOFILM REACTORS,” filed May 3, 2018, which is hereby incorporated by reference in its entirety for all purposes.

### BACKGROUND OF THE INVENTION

The present invention relates generally to the field of wastewater treatment systems. More particularly, the invention relates to techniques for applying oxidizing disinfectants with moving bed biofilm reactor (MBBR) systems.

Certain wastewater treatment includes the use of moving bed biofilm reactor (MBBR) systems. The MBBR may include certain biofilm carriers suitable for the treatment of wastewater. For example, high density polyethylene (HDPE) biofilm carriers may operate in mixed motion within an aerated wastewater treatment basin. Each individual biocarrier may increase productivity by providing a protected surface area to support the growth and sustenance of microbial population on the surface of the biocarrier media, resulting in a high density population of bacteria. This high-density population of bacteria may achieve high-rate biodegradation within the system, while also offering process reliability and ease of operation. It may be beneficial to improve disinfection processes.

### BRIEF DESCRIPTION OF THE INVENTION

Embodiments include MBBR systems coupled to or including disinfection systems. The disinfection systems may include a chlorine disinfection system, a UV disinfection system, a peracetic acid (PAA) disinfection system, a ferrate disinfection system, or a combination thereof, located upstream of the MBBR systems, downstream of the MBBR systems, or inside of the MBBR systems.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a wastewater treatment system including a moving bed biofilm reactor (MBBR) system with at least one disinfection system; and

FIG. 2 is a flowchart of an embodiment, of a process suitable for applying the systems of FIG. 1.

### DETAILED DESCRIPTION OF THE INVENTION

Wastewater treatment systems generally include several system components that treat and condition wastewater for disposal into the environment (e.g., lakes, rivers, ponds, etc.) and for a variety of uses (e.g., irrigation, recycling of water, etc.). Certain wastewater treatment processes include the use of moving bed biofilm reactor (MBBR) systems. The MBBR may include certain biofilm carriers suitable for the treatment of wastewater. For example, high density polyethylene biofilm carriers may operate in mixed motion within an aerated wastewater treatment basin. Each individual biocarrier may increase productivity by providing a protected surface area to support the growth of heterotrophic and autotrophic bacteria within cell of the biocarrier, resulting in a high density population of bacteria. It may be beneficial to combine MBBR systems with disinfection systems, such as oxidizing disinfection systems that use chlorine, ultraviolet (UV) irradiation, peracetic acid (e.g., organic compounds with the formula CH3COOOH), ferrates (e.g., [FeO₄]²⁻), or a combination thereof.

The techniques described herein may include a skid system process train, where a skid may include an MBBR system. The MBBR skid may include a disinfection system, or may be fluidly coupled to other skids that include disinfection systems. The disinfection systems may include chlorine based disinfection, ultraviolet (UV) based disinfection, peracetic acid based disinfection, and/or ferrate based disinfection. Accordingly, the disinfection systems may be located upstream of the MBBR system, downstream of the MBBR system, or in the MBBR system.

The MBBR and/or disinfection systems may be included in wastewater treatment systems such as aerated treatment units (ATUs), small community plants (SCPs), and/or lagoons. By adding the techniques described herein to ATUs, SCPs, and/or lagoons, a release of treated effluent into the environment may include reduced quantities of pathogens, disinfection byproducts (DBPs), and new categories of emerging pollutants such as Pharmaceuticals and Personal Care Products (PPCPs) and Endocrine Disrupting Chemicals (EDCs).

In certain locales, such as in the state of Louisiana, a significant portion of small residential and commercial entities are serviced by onsite, Aerated Treatment Units (ATUs) and small community plants (SCP) for the treatment of sanitary wastewater. The majority of these systems may be malfunctioning, thereby releasing insufficiently treated wastewater into the waterways. The effluent from these ATUs may be discharged into stormwater drainage ditches in front of businesses and along streets and highways, frequently resulting in standing, stagnating water contaminated with sewage. Ditches drain to local waterways, contaminating them with fecal pathogens, nutrients, and organic materials. Water quality in these waterways may be greatly diminished, as breakdown of the organic material depletes water dissolved oxygen levels. Consequently, the waterways become impaired for parameters such as dissolved oxygen and fecal coliform bacteria.

To address this situation, some agencies, such as the Louisiana Department of Environmental Quality (LDEQ) has established Total Maximum Daily Loads (TMDLs) limits on streams listed as impaired on EPA's Impaired Waterbodies List. Many streams in Louisiana received TMDLs for Dissolved Oxygen Demanding Substances and/or fecal coliform bacteria. While there are no established nutrient TMDLs in Louisiana for nitrogen and phosphorus, nutrients are implicated in the aforementioned DO and fecal coliform TMDLs. To address nutrient inputs, LDEQ completed a Nutrient Management Strategy (LDEQ, 2014) and has begun implementing elements of the plan, particularly by addressing point-sources of pollution (LDEQ, 2017).

As a consequence of the TMDLs and subsequent nutrient management strategy, LDEQ has implemented total nitrogen (TN) and total phosphorus (TP) monitoring in general and individual permits for all facilities requiring a Louisiana Pollutant Discharge Elimination System (LPDES) permit. This will allow LDEQ to gather data necessary to determine the extent of nutrient contributions from point-source dischargers to water bodies of Louisiana (LDEQ 2017).

Most significantly, however, small commercial ATUs discharging to streams with TMDLs will be given more stringent effluent limits, for which they were not designed (Table 1- LDEQ, 2017a). ATUs that are currently installed and operating will not be able to meet the new limits, which will result in fines and expenses for the treatment unit owners and operators.

TABLE 1
Standard and Waterway Parameter Effluent Example Limits,
Class 1 Sanitary Wastewater Plant. It is to be noted
that these limits are for example use only.

| (All units mg/L) | Standard Permit | | Permit - TMDL Waterway | |
|---|---|---|---|---|
| Parameter | Monthly | Maximum | Monthly | Maximum |
| BOD5/CBOD5 | 30 | 45 | 5 | 10 |
| TSS | 30 | 45 | 5 | 10 |
| Oil/Grease | | 15 | | 15 |
| NH3—N | 4-10 | 8-20 | 2 | 4 |
| TN | report | | report | |
| TP | report | | report | |

In addition to the above, other examples include a Fecal Coliform (FC) limit calls for 200 MPN/100 mL and 400 MPN/100 mL as monthly and weekly geometrical average values. Given the impending stringent wastewater effluent limits, there is a need to cost-effectively retrofit existing small commercial ATUs to meet new effluent discharge standards. The techniques described herein include up and coming disinfection processing paired with bioaugmentation, resulting in technology potentially capable of addressing this need.

Reuse of treated wastewater is very important in many communities to fulfill water needs round the year. Effluent from treatment plants need advanced treatment steps for reuse applications. Primarily reused water is utilized for irrigation, and the level of treatment depends upon quality of the product, based on specific application. A few of the common tertiary treatments are:
Polishing residual effluent from an overloaded plant that needs further treatment to fulfill BOD, TSS and ammonia-N limits for reuse applications.
Nitrification of treated effluent from an operating plant that removes BOD only.
Inactivation of pathogens (bacteria and viruses).

Advanced treatment needs may be fulfilled by fixed film bioreactors, specifically MBBR as described herein, which are very effective for polishing application requiring limited footprint area.

Additionally, rural communities that do not have access to a treatment plant, and depend upon septic systems, can also utilize wastewater for reuse by treating it in small package plants. Benefits of replacing septic to community based packaged treatment systems are:
It eliminates leaching of septage and contamination of groundwater; it eliminates the need for periodic hauling of septage to distant and centralized treatment plants; and it can produce treated effluent suitable for reuse by disinfection.

### Embodiments

Embodiments include integrated disinfection with bioaugmentation utilized in MBBR reactors to enable an inexpensive simple process for SCP, ATU's, and lagoons. The MBBR will be enhanced by the disinfection process in front and/or in other locations. Certain oxidants (e.g., PAA and Chlorine) will inactivate the pathogens and enhance the MBBR process. The MBBR process will degrade the disinfection by-product and refractory organics, including endocrine disrupting compound (EDC's).

### Disinfection Embodiments

Disinfection is an essential step for discharge or reuse. Applying the right technology protocols for wastewater disinfection and reuse has become more complex than before in order to address several public health issues. In addition to traditional disinfection challenges for a wide range of pathogens, the generation of a larger number of potentially harmful disinfection byproducts (DBPs) and new categories of emerging pollutants such as Pharmaceuticals and Personal Care Products (PPCPs) and Endocrine Disrupting Chemicals (EDCs) must now also be considered. Various disinfection embodiments may be used, including: chlorination, UV radiation, ozonation, peracetic acid (PAA), and ferrate along with utilization of fixed film biological reactors, particularly MBBR. Newer technologies ferrate and peracetic address the greatest number of emerging public health and environmental considerations at lower cost compared to ozonation and UV irradiation. Specifically, ferrate and peracetic acid:
Produce a pathogen free effluent with respect to E. coli, enterococci, bacterial phages, endospores and protozoan oocysts even in wastewater effluent with high suspended and dissolved solids concentrations.
Alters and converts the difficult to remove, refractory organics such as EDCs and PPCPs in wastewater effluents to degradable compounds.
Does not produce harmful disinfection by-products or chlorinated intermediates.
The incorporation of media based reactors will reduce the organic loading to the oxidative disinfectants.
The incorporation of media based reactors will also enhance breakdown of refractory organics constituents in the reactor leading to a reduction in the demand on the oxidative disinfectants.

Ferrate may also provide an additional benefit in that the iron ions may complex with phosphorus and other chemical species in anionic, colloidal and particulate forms by adsorption to the residual ferric hydroxide. This action provides a slow nutrient release to land application sites. Utilization of ferrate may also add iron as a micronutrient to accelerate plant growth. Peracetic acid is innovative and being applied in a small number of wastewater plants in the United States while being utilized in a number of facilities in Europe. In addition, the usage of ozone is becoming more economical with advances in operational controls.

Data suggests that polishing the wastewater effluent with a MBBR reactor after disinfection will reduce the environmental impact of the residual organics. It should be noted that these reactors can polish effluents coming from over loaded activated sludge plants or package plants found in small communities. Data concerning this operation may be presented along with disinfection data shown in Tables 2 and 3.

TABLE 2
Disinfection Processes Operational Cost and Concerns

| | Health | | |
|---|---|---|---|
| | and Safety | Maintenance | Operational |
| Process | Concerns | Issues | Costs |
| Chlorine | Cl₂ Gas: Potential | Cl₂ Gas: Highly | Nominal power |
| | for explosion, | corrosive. | consumption to |
| | severe respiratory | Handling and | operate equipment |
| | effects, Potential | safety equipment | |
| | terrorism target, | and training | |
| | Hypochlorite | requirements. | |
| | Moderate | Hypochlorite: | |
| | occupational | Bleach handling | |
| | exposure risk | less dangerous, | |
| | | slight scaling | |
| | | potential | |
| UV | Low risk of | High maintenance | Medium power |
| | exposure to UV | costs associated | requirements |
| | irradiation | with fouling and | |
| | | replacement of | |
| | | lamps and ballasts. | |
| Ferrate | Slight emission of | System | Nominal power |
| | off-gases during | maintenance | consumption to |
| | synthesis and | requirement higher | operate equipment |
| | stored feedstock, | than normal due to | |
| | Bleach handling | scaling potential. | |
| | and alkaline | | |
| | operation | | |
| | conditions | | |
| Peracetic | The handling of | System | Nominal power |
| Acid | strong oxidant | maintenance | consumption to |
| | with standard eye | requirements | operate equipment |
| | and skin | slightly better than | |
| | protection. | bleach. | |

TABLE 3
Wastewater Disinfection Process Performance

| | By-Product | Performance at |
|---|---|---|
| Process | Formation | High TSS Levels |
| Chlorine | HAAs¹, THMs², | Low: Increase in |
| | and other | DBPs³ |
| | unidentified | |
| | halogenated DBPs | |
| Ferrate | Ferric Hydroxide | High: No |
| | | appreciable |
| | | concern for DPBs |
| Peracetic Acid | Acetic Acid and | High: No |
| | Water | appreciable |
| | | concern for DPBs |
| UV | No Residual | Low: Reduced due |
| | | to high TSS |
| | | blocking UV light |
| | | slightly better than |
| | | bleach. |

¹Haloacetic Acids,
²Trihalomethanes,
³Disinfection By-Products

### Parcetic Acid Embodiments

While chlorine has historically been widely utilized for wastewater disinfection, there have been growing concerns of disinfection byproducts (DBPs), effluent toxicity, endocrine disruption, and other unintended environmental impacts resulting from this practice. In recent years there has been building research momentum into safer disinfection alternatives. The disinfectant Peracetic Acid (PAA) has been gaining attention for its ability to reduce or eliminate DBPs, sodium pollution, and total dissolved salts in treated water, while providing disinfection comparable to chlorine.

PAA is a clear, colorless liquid formed by the oxidation of acetic acid by hydrogen peroxide. Its use doesn't result in halogenated byproducts or residuals, and the mutagenic and carcinogenic compounds are fewer in both quantity and composition after application of the disinfectant. PAA has bactericidal, virucidal, fungicidal, and sporicidal activity. It is generally thought that PAA's mode of activity is by denaturing proteins, disrupting cell wall permeability, and by oxidizing and denaturing essential cellular enzymes or proteins.

PAA may be incorporated into injectable liquid media and pumped into a contact chamber or tank. The pump and tank would provide the mixing and contact time needed before the effluent is discharged. The PAA can be purchased as a 2% (or stronger) concentrate, which could be diluted 1: 1000 or between 1:500 to 1:1500 (PAA to water), and injected into the tank using a peristaltic or diaphragm pump.

MBBR is a media based biological treatment system where the microbial population that carry out biological treatment remain attached as fixed films on to HDPE media surfaces and the media themselves are in constant motion due to the turbulence created by aeration. MBBR offers multiple benefits over traditional activated sludge process, as follows:
Requires limited footprint area as biomass population is equivalent to 1,000 to 5,000 mg/L as suspended solids.
Pre and post nitrification and denitrification and chemical phosphorus removal can be added to upgrade existing plants to nutrient removal facilities.
Resilient to peak flows and shock loads.
Resilient to temperature fluctuations.
Resistant to toxic shocks.
Free from sludge bulking due to filaments.
Simple, hands free operation.

All of the above features render MBBR very attractive as a packaged treatment system for small communities with the need to reuse treated effluent. The incorporation of MBBR reactors for post treatment (and/or pretreatment) may reduce the organic loading and refractory organic constituents on the oxidative disinfectants. Data suggests that polishing the wastewater effluent with a MBBR reactor before disinfection will reduce the environmental impact of the residual organics.

### Bioaugmentation Embodiments

Bioaugmentation is the process of adding selected bacteriological strains, enzymes, and other biologically active components to improve a treatment process. In short, augmentation improves the living conditions and metabolism of food sources for microbes that degrade pollutants in the treatment facility. Bioaugmentation is widely utilized in industrial and agricultural settings. For wastewater applications, bioaugmentation may be utilized as described herein in larger, municipal wastewater systems to improve the treatment process in the wastewater plant and to begin the waste break down process in the collection system, or in industry-specific cases (i.e.: paper and pulp industry). The application of bioaugmentation can have many beneficial outcomes, including reduced sludge growth in the wastewater facility; reduced odor; reduced fats, oil, and grease; enhanced breakdown of biological oxygen demanding organics and nutrients (including total nitrogen and total phosphorus); and cost savings for the owner/operator. Bioaugmentation has not yet been widely accepted for use in small ATUs and septic systems. However, with the implementation of Total Maximum Daily Loads (TMDLs) on many streams, local government officials and agencies are looking for alternative policies and technologies to improve wastewater treatment to meet stricter water quality effluent limits.

Moving Bed Biofilm Reactors (MBBR) can be utilized as a type of Bioaugmentation system which employs high density polyethylene biofilm carriers operating in mixed motion within an aerated wastewater treatment basin. Each individual biocarrier increases productivity through providing protected surface area to support the growth of heterotrophic and autotrophic bacteria. It is this high-density population of bacteria that achieves high-rate biodegradation within the system, while also offering process reliability and ease of operation. These MBBR systems potentially provide the greatest cost-effective treatment with minimal maintenance, since MBBR processes self- maintain an optimum level of protective biofilm. Additionally, the biofilm attached to the mobile biocarriers within the system automatically responds to load fluctuations.

PAA dosage may be administered based on the disinfection efficacy of indicator organisms, and the resulting effect on water quality. For example, a dosage of 5 mg/L (15%) PAA, with contact time of 20 minutes, can reduce fecal and total coliform by 4 to 5 logs in secondary effluent.

### Combination of Disinfectants and MBBR Embodiments

The usage of disinfectants before MBBR (e.g., upstream of MBBR) may be applied to one embodiment, and the oxidants can be used to enhance the effectiveness of the MBBR reactors by:
Optimizing efficiency of ATU's.
Treating refractory organics to a degradable form.
Degrading disinfectant by-products.
Enhancing the disinfection process.
Reducing EDC's.

Some concerns of ozone pretreating waste stream before MBBR process include:
Increased capital and O&M costs for facilities
Require more refined operations
Generate the disinfection by-product
Oxidize iron and manganese leading to fouling the MBBR media surfaces

The usage of PAA could have the positive effects similar to ozone but may be less impacting. The problem with the residual acetic acid would be removed by its degradation through the MBBR reactor downstream.

### Application of Embodiments

With small ATU's being mandated to meet effluent discharge limits for which they were not designed, a combination of bioaugmentation (MBBR)/PAA retrofit has broad application potential for numerous small residential and commercial ATUs discharging into community ditches not only in rural parts of the United States, but worldwide.

Over 40% of the small communities in Southeast Texas and Louisiana have been severely impacted by recent storms and flooding over the last year. This includes the ingress of raw sewage in these affected areas. As a result, the development of an inexpensive polishing system, which uses MBBR and the innovative disinfectant could increase the sustainability in the near future.

Additionally, rural and small communities that do not have access to a treatment plant, and depend upon septic systems, can also utilize wastewater for reuse by treating it in small package MBBR based plants.

Advanced treatment needs may be fulfilled by fixed film bioreactors, specifically MBBR, which are very effective for polishing application requiring limited footprint area.

Certain objectives of the embodiments is to retrofit existing commercial ATUs with oxidants (Chlorine, Ferrate, and PAA)/MBBR combination to improve effluent water quality, and to improve watershed water quality. Based on municipal-scale studies, the embodiments may decrease TSS, BOD, TN, TP, fats/oil/grease, fecal bacteria, and/or odor in the effluent and decrease excess sludge build-up within the ATU. The techniques described herein may result in reduced cost to the plant owner/operator due to reduced sludge removal from the ATU.

The results of the embodiments may be very relevant and beneficial specially to rural communities that do not have access to large scale treatment plants and are in need to reuse wastewater. In many cases these communities depend on septic systems, which are sources of groundwater contamination. Moreover, water hauled out as septage is essentially a loss of an important resource that could be utilized for beneficial purposes if it is properly treated. Additionally, hauling requires a very large cost due to transportation. The results of the techniques described herein may demonstrate the applicability of MBBR as small-scale package systems that do not need continuous monitoring by trained operators. The principal benefits to such communities will be:
Ability to reuse wastewater generated within the community for irrigation, landscaping, construction, agriculture, etc.
Inexpensive and simple package plants with small footprint requirement and very little sludge disposal requirement.
Simple to operate and maintain, with very little requirement of skilled labor.

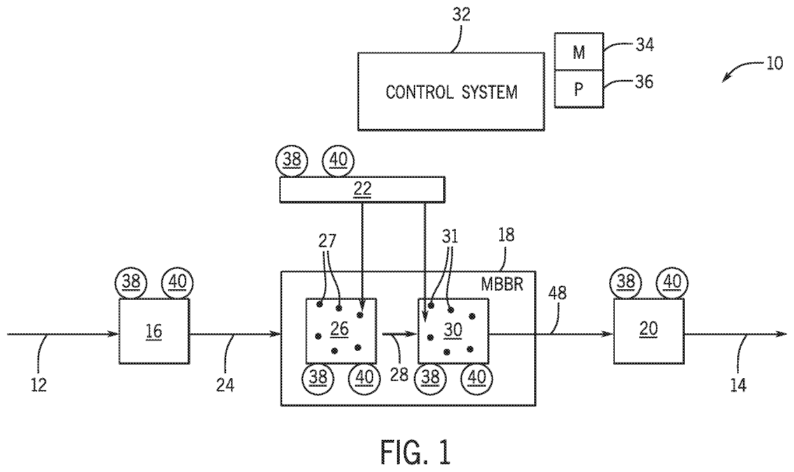

Turning now to the drawings, and referring first to FIG. 1, an embodiment of a wastewater treatment system or train 10 is illustrated. The wastewater treatment system 10 is designed to receive influent 12 (e.g., processed fluid, wastewater, and the like) and to output treated fluid 14. In the illustrated embodiment, the wastewater treatment system 10 includes a first disinfection system 16, a MBBR system 18, and a second disinfection system 20. The first disinfection system 16 may be a chlorine disinfection system, a UV disinfection system, a peracetic acid disinfection system, a ferrate disinfection system, or a combination thereof, located upstream of the MBBR system 18. The second disinfection system 20 may be a chlorine disinfection system, a UV disinfection system, a peracetic acid disinfection system, a ferrate disinfection system, or a combination thereof, located downstream of the MBBR system 18. It is also to be noted that in certain embodiments, only the first disinfection system 16, or only the second disinfection system 20, may be used. Further, a third disinfection system 22 may be used as part of certain components of the MBBR system 18 (e.g., in the MBBR system 18). The third disinfection system may be a chlorine disinfection system, a UV disinfection system, a peracetic acid disinfection system, a ferrate disinfection system, or a combination thereof.

Accordingly, the influent 12 may include wastewater to be treated, such as wastewater to be treated by an ATU, SCP, lagoon, and the likes. The influent 12 may enter the first disinfection system 16. The first disinfection system 16 may then apply disinfection techniques including chlorine disinfection, UV disinfection, peracetic acid disinfection, ferrate disinfection, or a combination thereof. Treated fluid 24 may then be directed for further processing, e.g., bioprocessing, via the MBBR system 18. The MBBR system 18 may include one or more reactors 26, 30. The MBBR reactor 26 may include a plurality of media 27, such as virgin high density polyethylene media, suitable for providing a scaffold for biological growth. The MBBR reactor 26 may utilize the attached growth on media 27 as a support for the formation of treatment biofilms. The media 27 is circulated by aeration or mixer(s) in a treatment reactor to provide for contact with the treated fluid 24. The MBBR media 27 provides large surface area for biofilm formation and growth.

In some embodiments, only a single reactor 26 may be used. Other embodiments, may use more than one reactor 26, such as two, three, four, five or more reactors. For example, effluent 28 from the MBBR reactor 26 may then be directed to the second MBBR reactor 30. The MBBR reactor 30 may also include plurality of media 31, such as virgin high density polyethylene media, suitable for providing a scaffold for biological growth. Similar to the reactor 26, the second MBBR reactor 30 may utilize the attached growth on media 31 as a support for the formation of treatment biofilms. The media 31 is also circulated by aeration or mixers (e.g., blade mixers, submersible pumps, other pumps, and so on) in a treatment reactor to provide for contact with the effluent 28 and substrate transfer to the biomass.

The techniques described herein may also provide for a control system 32 suitable for controlling operations of the system 10. The control system 32 may include one or more memories 34 storing computer code or instructions, and one or more processors 36 suitable for executing the computer code or instructions. The control system 32 may be communicatively coupled to one or more sensors 38 and operatively coupled to one or more actuators 40. The sensors 38 may include temperature sensors, voltage sensors, amperage sensors, chemical property (e.g., chemical makeup, chemical composition, quantity of certain chemicals) sensors, flow sensors, limit switches, pressure sensors, and the like. The actuators 40 may include valves, pumps, fans, positioners, and so on. In operation, the control system 32 may sense characteristics of the influent 12, pretreated effluent 24, nitrified or denitrified effluent 28, and/or operational characteristics of the systems 16, 28, 30 (e.g., mixing rates, fluid flow rates, temperatures, pressures, fluid levels, and so on) to control the actuators 40.

The control system 32 may also control addition of chlorine, UV irradiation, peracetic acid, ferrate, as well as control of the transfer of fluids 12, 24, 28 (e.g., via valves, pumps, and so on). The control system 32 may use certain techniques, such as feedforward or predictive control techniques, for operational control of the system 10. For example, artificial intelligence (AI) techniques such as neural networks, state vector machines (SVMs), fuzzy logic control, expert systems, genetic algorithms, data mining control, and the like, may be used. Neural networks and/or SVMs may be trained via empirical data and/or simulator data to recognize patterns in sensor signals or data and then derive resulting control signals suitable for operating the actuators. For example, chlorine, ferrate, peracetic acid, may be added, fluid may be UV irradiated, fluid flow may be adjusted, and so on.

Expert systems may include rules, such as “if . . . then . . . ” rules that encapsulate human knowledge of certain control, such as disinfection/MBBR control. The rules may include forward and/or backward chained rules that fire based on the sensor signals or data and control the actuators. Fuzzy logic control may include fuzzy value and rules useful in feedforward control, such as in ratio control or ORP control. Genetic algorithms may be evolved with empirical and/or simulator data, that may then enable control of the system 10 by using sensor signals and/or data. Likewise, data mining may be used to build clusters and/or other structures useful in controlling the system 10, including disinfection/MBBR control.

The MBBR system 30 may enable the effluent 28 to be further processed, if multiple MBBR stages are desired. Once the control system 32 derives that fluid in the MBBR stage 30 is processed as desired, the control system 32 may transfer the fluid 48 into the second disinfection system 20 (if there is a downstream disinfection system).

The second disinfection system 20 may then process the fluid 48 by chlorine UV irradiation, peracetic acid, ferrate addition. The third disinfection system 22 may also process fluid in the MBBR stages by chlorine UV irradiation, peracetic acid, ferrate addition. The effluent 14 may then conform to certain regulations, such as Clean Water Act (CWA) regulations. It is to be understood that the system 10 subsystems such as the 16, 20, 22, 26, 30, may be disposed in various configurations, such as inside of three skids or more, or may be incorporated into a single skid, one or more buildings, and so on.

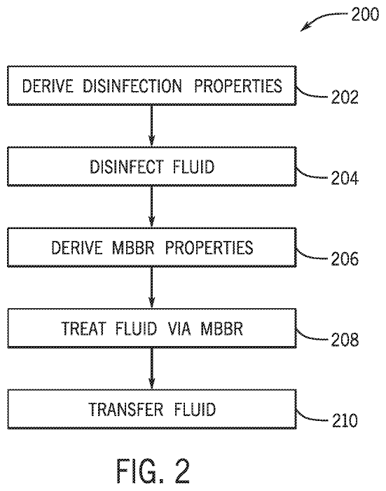

Turning now to FIG. 2, the figure illustrates an example, process 200 suitable for processing fluid via a combination of disinfection and/or MBBR techniques, for example, of the system 10. The process 200 may be implemented as computer code or instructions stored in the memory 34 and executable via the processor 36. In the depicted embodiment, the process 200 may derive (block 202) certain disinfection properties, such as amount of chlorine, amount of ferrate, amount of peracetic acid, UV levels, and so on, to apply to fluids such as the fluids treated by the disinfection systems 16, 20, 22. Other derived (block 202) properties may include exposure times of the fluids treated by the disinfection systems 16, 20, 22 to the chlorine, UV radiation, peracetic acid, ferrate, and the like. Yet other derived (block 202) properties may include quantities of other additives, temperatures, agitation rates, and the like, for the disinfection systems 16, 20, 22. The derivation (block 202) may include using certain models of disinfection, such as models based on experimental observation of the application of chlorine, UV radiation, peracetic acid, ferrate, or a combination thereof, to one or more types of wastewaters. The models may also include feedback models, feedforward models, neural networks, genetic algorithms, and so on, that may predict disinfection results in the one or more types of wastewaters.

The process 200 may then, via the disinfection systems 16, 20, 22, disinfect (block 204) the fluid undergoing treatment (e.g., wastewater). In certain embodiments, the disinfection (block 204) may happen upstream of the MBBR system 18, downstream of the MBBR system 18, and/or in the MBBR system 18. Disinfection (block 204) may include applying chlorine, ferrate, peracetic acid, and/or UV irradiation, to the fluid undergoing treatment. Disinfection (block 204) may additionally include applying additives, mixing the fluid, sensing the fluid (e.g., sensing for pathogens and/or pathogen levels), applying a desired temperature, providing for a desired fluid flow level, waiting desired time after application, and so on.

The process 200 may derive (block 206) certain MBBR properties. For example, once the fluid is received by the MBBR for treatment, the derived (block 206) properties may include an MBBR-processing time, a temperature, a fluid flow, a fluid volume, and so on. The derivation (block 206) may include using certain models of MBBR operations, such as models based on experimental observation of the growth of biofilm, results of biofilm treatment of wastewater disinfected upstream of the MBBR system 18, downstream of the MBBR system 18, and/or in the MBBR system 18 . The models may also include feedback models, feedforward models, neural networks, genetic algorithms, and so on, that may predict MBBR treatments results in the one or more types of wastewaters that may have undergone disinfection by the systems 16, 20, and/or 22.

The process 200 may then, via the MBBR systems 18, treat fluid (block 208) in the MBBR system 18. The treatment (block 208) may include using the MBBR reactors 26 and/or 30, to treat fluid entering the MBBR system 18 for a desire time, based on a sensed temperature, and the like. The process 200 may then transfer (block 210) the MBBR-treated fluid, for example for further treatment or for release to the environment.

This written description uses examples to disclose the present embodiments, including the best mode, and also to enable any person skilled in the art to practice the disclosed embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a disinfection system configured to disinfect a first fluid, and
a moving bed biofilm reactor (MBBR) system configured to treat a second fluid, wherein the disinfection system is fluidly coupled to the MBBR system upstream of the MBBR system, downstream of the MBBR, or wherein the disinfection system is disposed in the MBBR system.

2. The system of claim 1, wherein the disinfection system comprises a ferrate disinfection system.

3. The system of claim 2, wherein the ferrate disinfection system comprises a ferrate injection system configured to inject [FeO₄]²⁻ into the first fluid.

4. The system of claim 1, wherein the disinfection system comprises a peracetic acid disinfection system.

5. The system of claim 4, wherein the peracetic acid disinfection system comprises a peracetic acid injection system configured to inject a peracetic acid diluted between 1:500 to 1:1500 in water into the first fluid.

6. The system of claim 1, wherein the disinfection system comprises an ultraviolet (UV) radiation source configured to irradiate the first fluid with a UV radiation.

7. The system of claim 1, wherein the MBBR system is disposed downstream of the disinfection system and is configured to receive treated first fluid incoming from the disinfection system as the second fluid and to treat the second fluid with biological techniques.

8. The system of claim 7, comprising a second disinfection system disposed downstream of the MBBR system, wherein the second disinfection system is configured to receive the second fluid after treatment as a treated fluid and to disinfect the treated fluid.

9. The system of claim 8, wherein the second disinfection system comprises a chlorine disinfection system, a UV disinfection system, a peracetic acid disinfection system, a ferrate disinfection system, or a combination thereof.

10. The system of claim 1, comprising a control system configured to sense a disinfection metric and to adjust, via the disinfection system, a ferrate injection, a peracetic acid injection, a UV radiation, a chlorine injection, or a combination thereof.

11. A method comprising,
disinfecting, via a disinfection system, a first fluid; and
treating, via a moving bed biofilm reactor (MBBR) system, a second fluid, wherein the disinfection system is fluidly coupled to the MBBR system upstream of the MBBR system, downstream of the MBBR, or wherein the disinfection system is disposed in the MBBR system.

12. The method of claim 11, wherein disinfecting, via the disinfection system, comprises adding to the first fluid a ferrate, a peracetic acid, an ultraviolet radiation, a chlorine, or a combination thereof.

13. The method of claim 12, wherein the ferrate comprises a [FeO₄]²⁻, and the peracetic acid comprises a dilution of at least 2% peracetic acid in a water to result in an acid-to-water ration of between 1:500 to 1:1500.

14. The method of claim 11, wherein the disinfection system is disposed upstream of the MBBR system.

15. The method of claim 14, comprising disinfecting, via a second disinfection system, a treated fluid produced by the MBBR system.

16. A non-transitory computer readable medium comprising executable instructions that when executed cause a processor to:
disinfect, via a disinfection system, a first fluid; and
treat, via a moving bed biofilm reactor (MBBR) system, a second fluid, wherein the disinfection system is fluidly coupled to the MBBR system upstream of the MBBR system, downstream of the MBBR, or wherein the disinfection system is disposed in the MBBR system.

17. The non-transitory computer readable medium of claim 16, comprising instructions that when executed causes the processor to disinfect, via the first disinfection system, by adding to the first fluid a ferrate, a peracetic acid, an ultraviolet radiation, a chlorine, or a combination thereof.

18. The non-transitory computer readable medium of claim 17, wherein the ferrate comprises a [FeO₄]²⁻, and the peracetic acid comprises a dilution of at least 2% peracetic acid in a water to result in an acid-to-water ration of between 1:500 to 1:1500.

19. The non-transitory computer readable medium of claim 16, wherein the disinfection system is disposed upstream of the MBBR system.

20. The non-transitory computer readable medium of claim 19, comprising instructions that when executed cause the processor to disinfect, via a second disinfection system, a treated fluid produced by the MBBR system.
